(19) United States
(12) Patent Application Publication
(10) Pub. No.: US 2018/0076456 A1
(43) Pub. Date: Mar. 15, 2018

(54) SILICATE MATERIALS HAVING AN OLIVINE STRUCTURE

(71) Applicant: Commissariat A L'Energie Atomique et aux Energies Alternatives, Paris (FR)

(72) Inventors: Guillaume Lefevre, Grenoble (FR); Jean-Baptiste Ducros, Sassenage (FR); Sebastien Martinet, St Quentin sur lsere (FR)

(73) Assignee: Commissariat A L'Energie Atomique et aux Energies Alternatives, Paris (FR)

(21) Appl. No.: 15/701,961

(22) Filed: Sep. 12, 2017

(30) Foreign Application Priority Data
Sep. 12, 2016 (FR) 16 58466

(51) Int. Cl. H01M 4/58; C01B 33/32

(52) U.S. Cl. CPC H01M 4/5825; C01B 33/32; C01P 2002/30; C01P 2006/40; H01M 2004/028; C01P 2004/03; C01P 2004/04; C01P 2004/64; C01P 2002/72

(57) ABSTRACT

The present invention relates to a product constituted totally or partly by a material of olivine crystallographic structure of formula:

AₐZ_{z}MₘSiO₄

in which A is chosen from lithium (Li), sodium (Na), potassium (K) and mixtures thereof, Z is chosen from beryllium (Be), magnesium (Mg), calcium (Ca), strontium (Sr), barium (Ba), and mixtures thereof, M is chosen from iron (Fe), nickel (Ni), cobalt (Co), manganese (Mn), chromium (Cr), and mixtures thereof, a, z and m are the stoichiometric coefficients, respectively, of A, Z and M, and satisfy the following conditions: z>0, m>0, a>0, a+z+m≦2, and 2≦(4−a−2z)/m<4.

The present invention relates to a silicate product of Olivine crystallographic structure, intended especially for a battery, and also to methods for manufacturing such a product.

Crystalline polyanionic materials are materials of interest for the battery industry, in particular lithium-ion batteries. However, to date, to the inventors' knowledge, only lithium iron phosphate LiFePO₄ is marketed. Unlike other materials for the positive electrode of a battery such as lamellar oxides and spinets, polyanionic materials have a structure stabilized by the covalency of the anionic group. They thus promote reliable functioning of a battery comprising them, limiting the risks of a runaway reaction of the battery by release of oxygen in the electrolyte, Such materials are described, for example, in U.S. Pat. No. 6,085,015, U.S. Pat. No. 6,514,640 B1 and EP 1 134 826 A1.

Phosphate, borate, sulfate and silicate and the pyro- and fluoro-subforms thereof are base polyanions for making such polyanionic materials. In particular, silicate-based polyanionic materials, known as silicates, appear to be the most advantageous given that the operating safety and reliability of the battery must be ensured.

For example, a silicate material of formula Li₂MSiO₄ is known, with M being a transition metal chosen from iron (Fe), manganese (Mn), cobalt (Co) and nickel (Ni). Such a silicate material is described for example in US 2012/0227252 A1. The crystallographic structure of these silicate materials consists of a stack of LiO₄, MO₄ and SiO₄ tetrahedra, These silicates have a high theoretical specific capacity of between 325 mAh/g and 333 mAh/g which is about twice as high as that of mixed oxides such as LiCoO₂, LiNi_{0.8}Co_{0.15}Al_{0.05}O₂ (NCA), LiNi_{1/3}Co_{1/3}O₂ (NMC), LiMnO₄ (LMO) and lithium iron phosphate LiFePO₄.

For use as a lithium-ion battery cathode, the silicate Li₂MnSiO₄ is the most suitable since it has lithium insertion potentials for the couples Mn²⁺/Mn³⁺ and Mn⁺/Mn⁴⁺ (of 4.1 V and 4.5 V, respectively) that are both lower than the potential from which point degradation of the organic electrolytes for a lithium-ion battery is observed (4.6 V).

However, when it forms a lithium-ion battery cathode, the silicate Li₂MnSiO₄ abruptly amorphizes from the very first charge, which is reflected by a gradual loss in performance in the course of the charging/discharging cycles of the battery.

There is thus a need for a crystalline silicate material, comprising an alkali metal, especially lithium, and which, when it forms a battery cathode, especially a lithium-ion battery cathode, conserves its crystallographic structure in the course of the charging/discharging cycles of the battery.

This need is satisfied by means of a product constituted totally or partly by a material of olivine crystallographic structure of formula (I):

AₐZ_{z}MₘSiO₄

in which:
A is chosen from lithium (Li), sodium (Na), potassium (K), and mixtures thereof,
Z is chosen from beryllium (Be), magnesium (Mg), calcium (Ca), strontium (Sr), barium (Ba), and mixtures thereof,
M is chosen from iron (Fe), nickel (Ni), cobalt (Co), manganese (Mn), chromium (Cr), and mixtures thereof,
a, z and m are the stoichiometric coefficients, respectively, of A, Z and M, and satisfy the following conditions:

z>0, m>0, a>0

a+z+m≦2, and

2≦(4a−2z)/m<4.

The olivine crystallographic structure of the material of formula (I) promotes the insertion and extraction of the element A. The material according to the invention is thus perfectly suitable for forming a battery cathode. The element A is in fact extracted from the cathode during charging and inserted into the cathode during discharging of the battery.

Although the properties of the material of formula (I) have already been theoretically predicted, according, to the inventors, the manufacture and production of the, material of formula (I) have, hitherto, never been reported in the scientific and technical literature.

For example, the article “Is it possible to prepare olivine-type LiFeSiO₄? A joint computational and experimental investigation”, M.E. Arroyo y de Dompablo et al., Solid State tonics, 179 (2008), 1758-1762, describes attempts to obtain a silicate LiFeSiO₄ of olivine structure, which failed.

A manufacturing method, referred to hereinbelow as the “first method”, is thus proposed, according to one of the aspects of the invention, this method comprising at least the successive steps consisting in:

a) having a first material comprising at least one alkali metal A chosen from lithium (Li), sodium (Na), potassium (K), and mixtures thereof, and

a second material of olivine crystallographic structure of formula (III):

Z_{′}M_{m′}SiO₄,

in which:
Z is chosen from beryllium (Be), magnesium (Mg), calcium (Ca), strontium (Sr), barium (Ba), and mixtures thereof,
M is chosen from iron (Fe), nickel (Ni), cobalt (Co), manganese (Mn), chromium (Cr) and mixtures thereof,
z′>z, z being as defined previously, and
m as defined previously,

b) maintaining a liquid bath comprising, preferably constituted by, the first molten material and the second, material in solid form, at a maintenance temperature and for a maintenance time at this temperature that are suitable for the insertion of an alkali metal A chosen from lithium (Li), sodium (Na), potassium (K), and mixtures thereof, and provided by the first material in free sites of the olivine crystallographic structure of the second material so as to form a product according to the invention,

c) optionally, cooling of the liquid bath, and

d) optionally, washing and then drying.

According to another of its aspects, the invention relates to a method for manufacturing a material of olivine crystallographic structure of formula (I):

AₐZ_{z}MₘSiO₄

in which:
A is chosen from lithium (Li), sodium (Na), potassium (K), and mixtures thereof,
Z is chosen from beryllium (Be), magnesium (Mg), calcium (Ca), strontium (Sr), barium (Ba), and mixtures thereof,
M is chosen from iron (Fe), nickel (Ni), cobalt (Co), manganese (Mn), chromium (Cr), and mixtures thereof,
a, z and m are the stoichiometric coefficients, respectively, of A, Z and M, and which satisfy the following conditions:

z>0, m>0, a>0,

a+z+m≦2, and

2≦(4−a−2z)/m<4

said method comprising at least the steps consisting in:

i. having a material of olivine crystallographic structure of formula (II):

obtained by oxidation of a material of olivine crystallographic structure of formula (III):

Z_{z′}MₘSiO₄,

in which Z, M, z and m are as defined above and the stoichiometric index z′ such that z′>z, and

ii. electrochemically reducing said material of formula (II) in the presence of a source electrode made of element A under conditions that are suitable for forming the material of formula (I).

Said method will be referred to hereinbelow as the “second method”. Preferably, the material of formula (I) obtained via the second method is constitutive of the product according to the invention.

The invention also relates to a product obtained via the first method and also to a product obtained via the second method.

Moreover, the invention relates to a battery cathode, chosen especially from a lithium-ion (Li-ion) battery cathode, a sodium-ion (Na-ion) battery cathode, a potassium-ion (K-ion) battery cathode, a lithium (Li) battery cathode, a sodium (Na) battery cathode and a potassium (K) battery cathode, said battery cathode comprising a product according to the invention, or obtained according to the first method according to the invention and/or via the second method according to the invention.

Finally, the invention relates to a battery, preferably chosen from a lithium-ion battery, a sodium-ion battery, a lithium battery and a potassium battery, the battery comprising a battery cathode according to the invention.

Other advantages of the invention will emerge on reading the detailed description that follows, and by means of the attached drawing, in which:

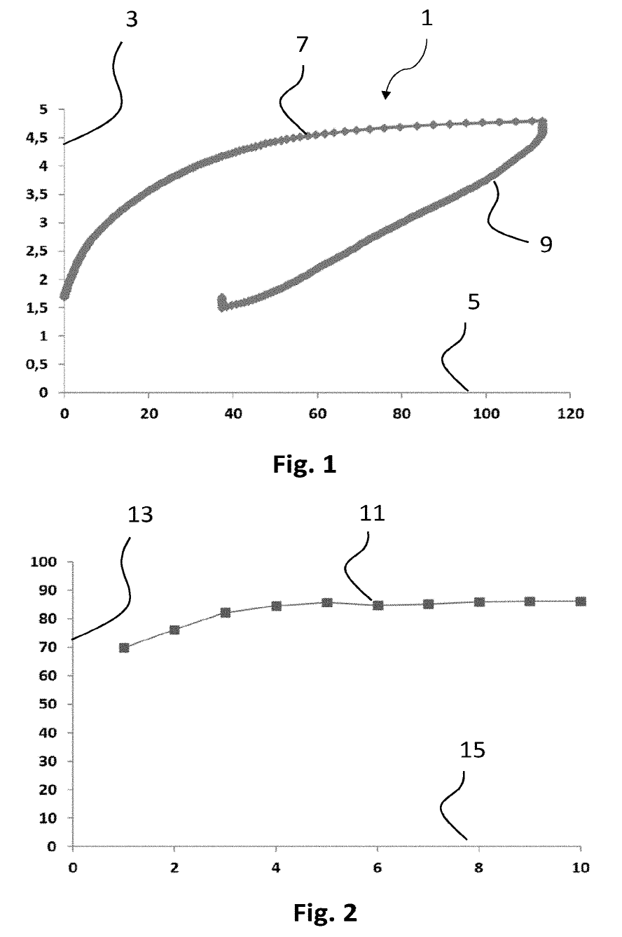

FIG. 1 is a graph representing the change in the potential, in V vs Li⁺/Li, as a function of the net specific capacity, in mAh/g, of a positive electrode of a battery comprising an implementation example of the product according to the invention, and

FIG. 2 is a graph representing the change in the specific capacity, in mAh/g, of the positive electrode of the battery of FIG. 1, as a function of the number of charging/discharging cycles,

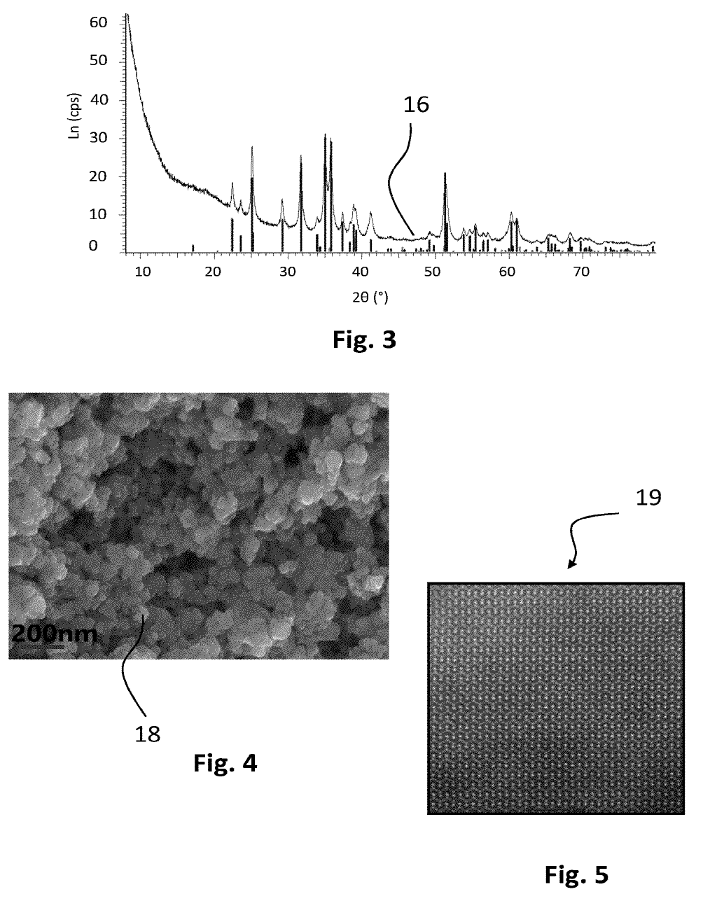

FIG. 3 is an X-ray diffractogram of a compound MgMnSiO₄/C prepared in the context of an example of implementation of the first method according to the invention,

FIG. 4 is an image of the compound MgMnSiO₄/C of FIG. 3 taken by scanning electron microscopy,

FIG. 5 is a diffraction image of a particle forming the compound MgMnSiO₄/C of FIG. 3 acquired using a transmission electron microscope,

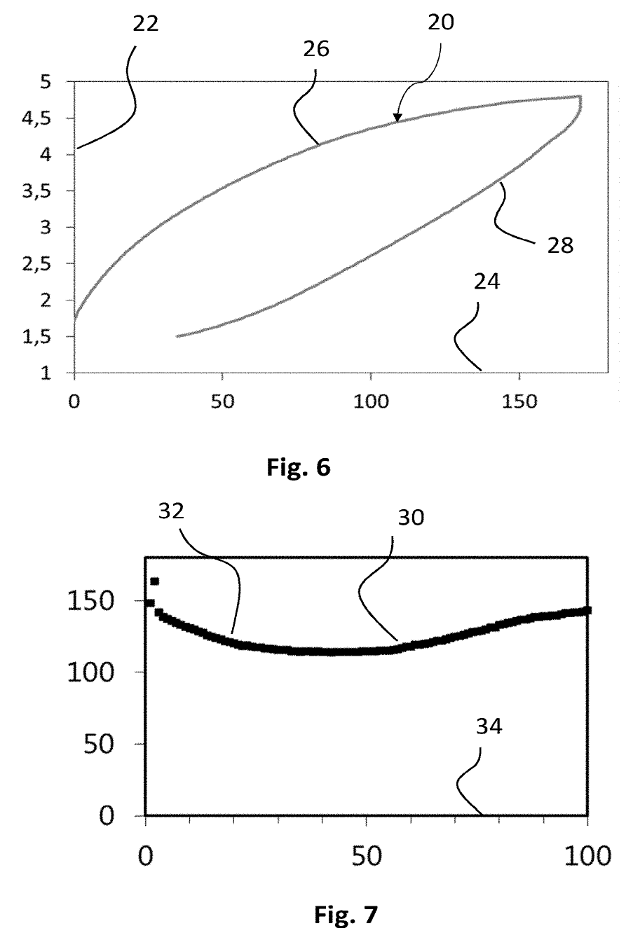

FIG. 6 is a graph representing the change in potential, in V vs Li⁺/Li, as a function of the net specific capacitance, in mAh/g, of a positive electrode of a battery comprising a second exemplary embodiment, of the product according to the invention, and

FIG. 7 is a graph representing the change in specific capacitance, in, mAh/g, of the positive electrode of the battery of FIG. 6. as a function of the number of charging/discharging cycles.

### PRODUCT

The product according to the invention is constituted totally or partly by a material of olivine structure of formula AₐZ_{z}MₘSiO₄.

In particular, the sum of the stoichiometric coefficients a+z+M may be greater than 1, or even greater than 1.5, or even greater than 1.9, preferably greater than 1.95, or even preferably greater than 1.99.

Preferably, the sum of the stoichiometric coefficients a+z+m is equal to 2. Each octahedral site of the crystallographic structure of the material is then occupied by one of the elements A, Z and M.

In particular, the stoichiometric coefficients a, z and m may be such that z=1−a and/or m=1. Preferably, z=1−a and m=1. The specific capacity of the constitutive material of the product is then optimal.

The stoichiometric coefficient a may be greater than 0.1, or even greater that 0.5. Preferably, it is greater than 0.9 and/or less than 1, in particular less than 0.999.

Preferably, the stoichiometric coefficient z is less than 1, preferably less than 0.5, preferably less than 0.1, preferably less than 0.05, better still less than 0.01. The number of sites in the olivine structure that are available to the element A is then increased, which promotes the production of a high specific capacity of the product.

The material is especially characterized in that the stoichiometric coefficient z is non-zero. As will be seen hereinbelow, this characteristic is a signature of the first and second methods. For example, in one embodiment, z is greater than 0.01, or even greater than 0.05, or even further greater than 0.1. The presence of the element Z, even in trace amount, in the material may be readily detected by ICP analysis (inductively-coupled plasma).

As regards the stoichiometric coefficient m, it is preferably between 0.9 and 1.1. Preferably, it is equal to 1.

Preferably, Z is chosen from magnesium (Mg), calcium (Ca) and mixtures thereof. In particular, Z is preferentially magnesium.

Preferably, A comprises, as a molar percentage expressed relative to the total number of moles of constituent alkali metal A, more than 90% of lithium and/or sodium.

Preferably, A is constituted to more than 99% of lithium, as a molar percentage expressed relative to the total number of moles of constituent alkali metal A. Preferably, A is lithium. A lithium-based material has optimum properties for forming a lithium-ion battery.

A particularly preferred product comprises, preferably for more than 95%, preferably for more than 99%, better still for substantially 100% of its mass, a material of formula LiₐMg_{z}MnₘSiO₄. Preferably, in this case, a>0.05, z<0.05 and m is between 0.98 and 1.02, preferably equal to 1.

The product according to the invention may be in various forms. For example, it may be in the form of a powder of secondary particles, for example sintered, constituted by the agglomeration of primary particles. In particular, the primary particles may have a size of less than 100 nm, preferably a size of less than 50 nm. The “size” of a primary particle corresponds to the diameter of said particle and may be measured from images acquired by scanning electron microscopy. The macroscopic electron conductivity of the product is then improved, In addition, the specific surface area of the particle is thus increased, facilitating exchange with the electrolytic medium when the product is placed in a battery. More preferably, the primary particles are covered, preferably entirely, with a layer of carbon whose thickness is less than 10 nm, to further improve the electron conductivity of the product.

The product may also be in the form of an electrode, in particular a battery cathode. Preferably, in this case, the product is in the form of particles made from the material of formula AₐZ_{z}MₘSiO₄ agglomerated together with carbon. For example, the product may comprise a mass proportion of the material of formula AₐZ_{z}MₘSiO₄ of greater than 50%, or even greater than 80%, very preferably greater than 90%, the remainder being constituted by, carbon and a polymeric binder. The electrode may also comprise an aluminum current collector on one of the faces of which the product is placed.

First Method

The product according to the invention may be obtained via the first method which is described below.

In step a) of the first method, the first material comprises at least one alkali metal A chosen from lithium (Li), sodium (Na), potassium (K), and mixtures thereof.

To manufacture a product according to the invention comprising a material including lithium, the first material may comprise a lithium salt, preferably chosen from the group formed by LINO₃, LiCl, LiBr, Lil, Li₂CO₃, and mixtures thereof. For example, the first material may be a mixture of LiNO₃ and LiCl. As a variant, the first material may also comprise a sodium salt and or a potassium salt, preferably chosen from the group formed by KCl, NaCl, NaBr, KBr, NaI, KI, NaNO₃, KNO₃, Na₂CO₃, K₂CO₃, and mixtures thereof. For example, it may be a mixture of LiCl and KCl.

To manufacture a product according to the invention comprising a material including sodium, the first material may be a sodium salt, preferably chosen from the group formed by NaCl, NaBr, NaI, NaNO₃, Na₂CO₃, and mixtures thereof. For example, the first material may be a mixture of NaNO₃ and NaCl. As a variant, the first material may also comprise a potassium salt, for example chosen from KCl, KBr, KI, KNO₃, K₂CO₃, and mixtures thereof.

To manufacture a product according to the invention comprising a material including potassium, the first material may comprise a potassium salt, preferably chosen from the group formed by KBr, KCl, KI, KNO₃, K₂CO₃, and mixtures thereof. For example, the first material may be a mixture of KNO₃ and KCl.

Needless to say, to manufacture a product comprising several elements from among, lithium, sodium and potassium, a mixture of lithium and/or sodium and/or potassium salts as listed above may be prepared.

Preferably, the first material is constituted by a mixture of salts forming a eutectic composition. The first material then has a moderate melting point, thus facilitating the implementation of the first method.

The first material may be in the form of a powder constituted of particles. The production of a liquid mass comprising the first molten material is thus facilitated.

Moreover, the first method uses a second material of olivine crystallographic structure of formula (III) Z_{z′}MₘSiO₄ in which Z is chosen from beryllium (Be), magnesium (Mg), calcium (Ca), strontium (Sr), barium (Ba), and mixtures thereof, and M is chosen from iron (Fe), nickel (Ni), cobalt (Co), manganese (Mn), chromium (Cr), and mixtures thereof.

Moreover, the stoichiometric coefficient z′ is positive. Preferably, the coefficient z′ is greater than or equal to 0.9 and/or less than or equal to 1.

In particular, the stoichiometric coefficient z′ may be equal to the sum of the coefficients z and a of the material according to the invention.

The coefficient m is positive. In addition, preferably, it is between 0.9 and 1.1. Preferably, it, is equal to 1.

In particular, the stoichiometric coefficient m of the second material is determined so as to define the stoichiometric coefficient of the material of formula AₐZ_{z}MₘSiO₄ which is constitutive of the product according to the invention.

The second material may be in various forms. It, may be in the form of a powder constituted of primary particles whose size is preferably less than 100 nm, preferably less than 50 nm in size. The particles may be agglomerated or aggregated together. Preferably, they are covered, preferably entirely, with a layer of carbon less than 10 nm thick.

A liquid bath is formed, comprising, preferably constituted by the first molten material and the second material in solid form.

Preferably, the liquid bath is obtained by partial fusion of a starting feed constituted of particles formed from the first material and of particles formed from the second material, and preferably intimately mixed. In particular, the mixing of the first and second materials may be performed using a mill.

Preferably, the partial melting is performed at a temperature above the melting point of the first material and below the degradation temperature of the second material.

The term “degradation temperature” means the temperature at and above which the material undergoes chemical and/or structural degradation, for example due to demixing a phase change, or amorphization.

Preferably, the melting point of the first material is below the degradation temperature of the second material, preferably by at least 100° C., or even at least 200° C.

For example, when the first material is, constituted by a mixture of LiNO₃ and LiCl, or by a mixture of LiCl and KCl, and the second material is MgMnSiO₄, the partial melting is performed at a temperature of between 200° C. and 500° C.

Preferably, the steps for mixing the first and second materials forming the starting feed are performed together with the step for heating the starting feed to form the liquid bath.

In one variant, in order to form the liquid bath, the first material may be heated in a crucible until a liquid molten mass is obtained. The second material may then be mixed with the liquid mass to form the liquid bath. For example, the second material may be poured into the mold containing the liquid mass. Alternatively, the liquid mass may be poured into a mold containing the second material.

In step b), the liquid bath is then maintained at a maintenance temperature and for a maintenance time at this temperature that are suitable for forming a material of olivine crystallographic structure of formula AₐZ_{z}MₘSiO₄ according to the invention.

The melting of the starting feed and/or the temperature maintenance of the liquid bath may be performed using any type of oven. For example, a muffle oven or a tubular oven comprising a quartz, porcelain, alumina, zirconia or platinum mold may be used,

Preferably, the maintenance temperature is above the melting point of the first material and below the degradation temperature of the second material. Preferably, it is at least 10° C. above the melting point of the first material and/or at least 10° C. below the degradation temperature of the second material.

The duration of temperature maintenance is preferably between five minutes and five days.

For example, when the first material is constituted by a mixture of LiNO₃ and LiCl, or by a mixture of LiCl and KCl, and the second material is MgMnSiO₄, the maintenance temperature is between 200° C. and 500° C., and the duration of temperature maintenance is between 2 hours and 2 days.

In step c), the liquid bath is cooled until it forms a solidified bath, preferably down to a temperature below 40° C. The solidified bath then comprises the product according to the invention and also residual compounds from the diffusion process of step b).

The solidified bath may be washed, in step d), so as to separate the product according to the invention from the residual compounds. The washing ma especially be performed with water or ethanol. The washed product according to the invention may then be dried, for example under vacuum, at a temperature above 60° C. and/or for a time of at least 12 hours.

Second Method

Alternatively to the first method described previously, a second method may be performed to manufacture the product according to the invention.

In step i), a material of olivine crystallographic structure of formula (II) Z_{z}MₘSiO₄ is provided, obtained by oxidation of a material of olivine crystallographic 30 structure of formula (III) Z_{z′}MₘSiO₄.

The material of Formula (III) of the second method according to the invention is especially identical to the second material of the first method according to the invention.

In particular, the stoichiometric coefficient z′ is greater than z. Preferably, z′ is less than or equal to 1.

As regards the material of formula (II), preferably, z is less than 1, preferably less than 0.5, preferably less than 0.1, or even preferably less than 0.05.

According to a first embodiment, the material of formula (II) Z_{z}MₘSiO₄ may be, prior to its reduction in step ii), generated by electrochemical oxidation of the constituent element M of the material of formula (III). By “electrochemical” reaction (and especially oxidation and reduction), a redox reaction is, considered involving an electron transfer, and performed using an electrochemical cell conventionally equipped with a working electrode, a counterelectrode, an electrolytic medium, and optionally a separator.

Preferably, the electrochemical oxidation is performed using an electrolytic medium comprising a source of element A.

In particular, the electrolytic medium used for the electrochemical reduction step may be identical to the electrolytic medium used for the electrochemical oxidation step.

For example, the element A is lithium and the electrolytic medium comprises a source of lithium, in particular in the form of a compound chosen from lithium hexafluorophosphate (LiPF₆), lithium perchlorate (LiClO₄), lithium arsenate (LiAsO₄), lithium tetrafluoroborate (LiBF₄) Lithium bis(trifluoromethanesulfonimide) (LiTFSI), lithium bis(oxalato)borate (LiBOB), lithium bis(fluorosulfonyl)imide (LiFSI), lithium hexafluoroarsenate (LiAsF₆), lithium triflate (LiSO₃CF₃), lithium trifluoroacetate (LiCF₃CO₂), lithium hexafluoroantimonate (LiSbF₆), LiN(CF₃SO₂)₃, LiN(C₂F₅SO₂) and mixtures thereof.

Moreover, the electrolyte may comprise, for example as solvent, a carbonate, chosen, for example, from ethyl carbonate, diethyl carbonate, ethyl methyl carbonate, dimethyl carbonate, propylene carbonate, and mixtures thereof. Preferably, the source of element A, for example of lithium, is dissolved in the carbonate.

Preferably, the material of formula (III) is oxidized as working electrode facing as counterelectrode. Thus, extraction of the Z²⁺ ions from the material of formula (III) is optimal. In any case, in order for the extraction of the Z²⁺ ions from the material of formula (III) to be able to take place, the redox potential of the counterelectrode must be less than the redox potential of the couple M²⁺/M³⁺ of the element M of the material of formula (III).

The material of formula (II) Z_{z}MₘSiO₄ is of olivine crystallographic structure. However, it is characterized in that the olivine crystallographic, structure has unoccupied sites, especially by the element Z. A characteristic of the second method lies, during the electrochemical reduction step ii), in the insertion into the unoccupied sites of one or more alkali metals A, so as to obtain the product according to the invention of formula (I) AₐZ_{z}MₘSiO₄.

The electrode may be in the form of particles of the material of formula (III) constituted of primary particles, preferably less than 100 nm in size, preferably less than 50 nm in size, and preferably covered, preferably entirely, with a layer of carbon, which is preferably less than 10 nm thick. The particles may especially be bound together by a carbon-based matrix, to improve the electrical conduction in the electrode and with a polymeric binder to ensure the cohesion and mechanical strength of the electrode.

For example, the counterelectrode is made of a material comprising the element A. Preferably, to manufacture a material of formula (I) with A being Li and/or Na and/or K, the counterelectrode is made of an Li and/or Na and/or K material, respectively, in metallic form.

In particular, during the electrochemical oxidation, the transition metal M may be oxidized from the state +2 to the state +4 and the ion Z²⁺ is extracted from the structure, according to the following redox half-equation:

Z_{z′}MₘSiO₄→Z_{z}MₘSiO₄+2(z′−z)e⁻÷(z′−z)Z²⁺

The electrochemical oxidation may be performed according to various modes, for example at constant current, at constant voltage, at imposed increasing current, at imposed increasing voltage. The temperature of the electrolyte may be between 20° C. and 60° C. The electrochemical oxidation is performed under a regime C/x, with x between 5 and 100, for example equal to 20. A regime C/x corresponds to charging performed in x hours. For example, a regime C/20 corresponds to charging in 20 hours.

After performing the electrochemical oxidation reaction, the product of formula (II) obtained may, be washed and then dried.

According to a second alternative embodiment, the material of formula (II) is, prior to its reduction in step ii), generated by chemical oxidation of the material of formula (III). The term “chemical oxidation” is considered here to be a reaction not requiring any electronic activation, contrary to an electrochemical oxidation.

Preferably, the chemical oxidation uses at least one oxidizing compound whose redox potential is greater than the redox potential of the couple M²⁺/M³⁺and/or of the couple M³⁺/M⁴⁺ of the constituent element M of the material of formula (III).

The oxidizing compound may especially be chosen from nitronium tetrafluoroborate (NO₂BF₄), potassium persulfate (K₂S₂O₈), nitrosonium hexafluorophosphate (NO₂PF₆), nitrosonium tetrafluoroborate (NOBF₄), hydrogen peroxide (H₂O₂), and mixtures thereof.

Preferably, the chemical oxidation is performed in a liquid bath containing at least said material of formula (III) and said oxidizing compound and under conditions suitable for extracting the element Z from said material of formula (III) to form said expected material of formula (II).

For example, the bath may comprise acetonitrile and the chemical oxidation reaction may be performed at a temperature of 60° C. at reflux for a time equal to 48 hours.

By way of illustration, the chemical oxidation of the material of formula (III) with nitronium tetrafluoroborate (NO₂BF₄), which has a potential of 5.1 V against the couple is performed according to the following reaction:

Z_{z′}MₘSiO₄+2(z′−z)NO₂BF₄→Z_{z}MₘSiO₄+2(z′−z)NO₂(g)+(z′−z)Z(BF₄)₂.

After performing the chemical oxidation, the material of formula (II obtained may be washed and then dried.

As has been described above, the material of formula (II) of the second method may then constitute the second material of the first method.

As a variant, according to the second method, whether it is obtained by chemical exchange or by electrochemical exchange, the material of formula (II) may be electrochemically reduced in the presence of a source electrode made of element A under conditions suitable for forming a material of formula (I).

In particular, to perform the electrochemical reduction in step ii), the material of formula (II) may form all or part of an electrode.

The electrode may be in the firm of particles of the material of formula (II), preferably less than 100 nm in size, preferably less than 50 nm in size, and preferably covered, preferably entirely, with a layer of carbon, which is preferably less than 10 nm thick. The particles may especially be bound together by a carbon-based matrix, to improve the electrical conduction within the electrode and by a polymeric binder to ensure the cohesion and mechanical strength of the electrode.

Preferably, the electrochemical reduction also uses a counterelectrode made of a material comprising the element A. Preferably, to manufacture a material of for (I) with A being Li and/or Na and/or K, the counterelectrode is made of an Li and/or Na and/or K material, respectively, in metallic form.

Preferably, the electrochemical reduction is performed using an electrolytic medium comprising, a source of element A.

In particular, the electrolytic medium used for the electrochemical reduction step in step ii) may be identical to the electrolytic medium used for the electrochemical oxidation step in step i).

For example, the Clement A is lithium and the electrolytic medium comprises a source of lithium, in particular in the form of a compound chosen from lithium hexafluorophosphate (LiPF₆), perchlorate (LiClO₄), lithium arsenate (LiAsO₄), lithium tetrafluoroborate (LiBF₄), lithium bis(trifluoromethanesulfonimide) (LITFSI), lithium bis(oxalato)borate (LiBOB), lithium bis(fluorosulfonyl)imide (LiFSI), lithium hexafluoroarsenate (LiAsF₆), lithium triflate (LiSO₃CF₃), lithium trifluoroacetate (LiCF₃CO₂), lithium hexafluoroantimonate (LiSbF₆), LiN(CF₃SO₂)₃, LiN(C₂F₅SO₂), and mixtures thereof.

Moreover, the electrolyte may comprise a carbonate chosen, for example, from ethyl carbonate, diethyl carbonate, ethyl methyl carbonate, dimethyl carbonate, propylene carbonate, and mixtures thereof. Preferably, the source of element A, for example of lithium, is dissolved in the carbonate.

Preferably, when the material of formula (II) is prepared by electrochemical oxidation, the electrode and the counterelectrode at the end of the electrochemical oxidation reaction step may constitute the electrode and the counterelectrode, respectively, at the start of the electrochemical reduction step. The temperature of the electrolyte may be between 20° C. and 60° C. The electrochemical oxidation is performed at a regime C/x, with x between 5 and 100, for example. equal to 20.

The electrochemical reduction step may be performed at constant current, constant voltage, imposed decreasing current, imposed decreasing voltage. However, it is not limited to this mode of implementation.

### EXAMPLES

### Example 1

An ink is prepared by mixing, in mass percentages, 10% of carbon super P-C65, 10% of polyvinylidene difluoride (PVDF) and 80% of a powder of MgMnSiO₄ particles with a mean size of 50 mm and covered with a layer of carbon.

The ink is coated on an aluminum strip and is then dried under vacuum at 60° C. for 24 hours. An electrode is then cut out of the aluminum strip coated with the ink that has dried. The electrode is then pressed, and then dried under vacuum at 80° C. for 48 hours.

An electrolysis cell in the form of a button cell of format CR2032 is manufactured and comprises the electrode including the material MgMnSiO₄ and a counterelectrode of metallic lithium (Li). A separator, constituted by a membrane of Viledon brand of reference FS 2207-2-DA WA and a Celgard 2400 membrane, is placed between the electrode and the counterelectrode. The electrodes, counterelectrode and separator are immersed in a liquid electrolyte constituted of a solvent formed from three equal parts of ethyl carbonate, diethyl carbonate and ethyl methyl carbonate, in which is dissolved lithium hexafluorophosphate (LiPF₆) at a concentration of 1 mol/l.

A first electrochemical oxidation phase is performed so as to partially extract the element Mg from the positive electrode MgMnSiO₄.

An electrochemical reduction phase is then performed, making it possible to insert lithium ions in place of the Mg ions extracted during the first redox phase, so as to form a material of formula LiₐMg_{z}MnSiO₄(with a<1 and z<1).

The electrolysis cell is then subjected to cycles formed from galvanostatic charging followed by galvanostatic discharging imposed at a regime of C/20-D20 between a potential of 1.5 V and 4.8 V vs. Li+/Li at 25° C.

FIG. 1 shows the change 1 in the course of a charging-discharging cycle a the potential 3 of the positive electrode LiₐMg_{z}MnSiO₄ (z<1 and a<1) as a function of the net specific capacity of active material 5. During the charging 7, Li⁺ ions are de-inserted from the positive electrode LiₐMg_{z}MnSiO₄ and are deposited on the negative electrode, so that a material of formula Li_{a′}Mg_{z}MnSiO₄ (with a′<a) is formed. During the discharging 9, the reverse redox reactions take place.

FIG. 2 represents the change 11 in the specific capacity of the positive electrode 13 in discharging as a function of the number of cycles 15.

As is seen, a reversible specific capacity of 85 mAh/g is obtained for the composite formed by the lithiated silicate and the carbon in layer form, which corresponds to a reversible capacity of 97 mAh/g for the lithiated silicate alone, and no degradation of the capacity is observed in the course of the cycles.

Moreover, both during charging and discharging, the electrochemically active material of the positive electrode conserves its olivine crystallographic structure, as may be seen by X-ray diffraction.

### Example 2

Step 1

A compound of formula MgMnSiO₄/C is synthesized via the sol-gel route. In a first beaker, 4.26 g of magnesium acetate, tetrahydrated for more than 95% of its mass, and 4.71 g of manganese acetate trihydrate and tetrahydrate are dissolved, with stirring, in an acidic aqueous solution formed from 1 ml of acetic acid diluted in 13.55 ml of deionized water. 15.00 g of P123 (PEO-PPO-PEO triblock copolymer) and 4.47 ml of tetraethoxysilane (TEOS) are dissolved in a second beaker with stirring. The solution contained in the first beaker is added to the second beaker. The mixture is stirred using a magnetic stirrer overnight. Gelation takes place after 4 days. The gel obtained is then air-dried at a temperature of 80° C. for one week. The xerogel thus obtained is ground and then pyrolysed in a half-tube in a tubular oven under argon for a time of 24 hours at a temperature of 900° C.

The X-ray diffractogram 16 illustrated in FIG. 3 indicates that the compound of formula MgMnSiO₄ obtained in the preceding paragraph crystallizes in the orthorhombic system of Pnma space group. As observed, in FIG. 4 the compound is in the form of primary particles 18 about 50 nm in size, and, as confirmed by the diffraction image 19 presented in FIG. 5, having a crystal structure whose space group is in accordance with that determined by means of the diffractogram of FIG. 3.

Step 2

Thereafter, 0.488 g of the compound of formula MgMnSiO₄/C obtained in step 1 is ground with 0.882 g of lithium chloride (LiCl) and 1.044 g of potassium chloride (KCl), corresponding to a eutectic composition of the LiCl-KCl binary diagram, so as to form a mixture.

The mixture is pyrolysed in a tubular oven under an argon atmosphere for a time of 40 hours at a temperature of 400° C. During the pyrolysis treatment, the eutectic LiCl-KCl composition melts and forms a bath of molten salts, in which a rearrangement of the elements Mg and Mn takes place in the crystallographic structure of MgMnSiO₄/C towards a more ordered state.

The MgMnSiO₄/C. powder resulting from the pyrolysis treatment is transferred into a glovebox while avoiding contact with the ambient air. It is washed with anhydrous ethylene glycol and dried under vacuum at a temperature of 150° C. for 24 hours.

Step 3

0.374 g of the MgMnSiO₄/C powder obtained at the end of step 2 is dispersed using 50 ml of anhydrous acetonitrile in a round bottomed flask in a glovebox. In another glovebox, 1.223 g of nitronium tetrafluoroborate are dissolved in 50 ml of anhydrous acetonitrile and introduced into a dropping funnel. The dropping funnel is then connected to the round-bottomed flask so that the assembly formed by the dropping funnel and the round-bottomed flask and the connecting means connecting them is leaktight and filled with argon. The whole is connected to a reflux assembly and is maintained under an argon atmosphere. The nitronium tetrafluoroborate solution is added dropwise to the dispersed powder contained in the round-bottomed flask. The round-bottomed flask is stirred and maintained at a temperature of 60° C. for a time of 32 hours. The powder thus treated is then washed with acetonitrile, and then filtered and dried at a temperature of 80° C. under vacuum.

In the course of step 3, the MgMnSiO₄/C powder is oxidized and magnesium atoms, are extracted from the sites they occupy in the olivine structure. A powder of Mg_{z}MnSiO₄/C particles with z<1 is thus obtained.

Step 4

An ink is then prepared, comprising, as mass percentages relative to the mass of ink, 80% of the Mg_{z}MnSiO₄/C powder obtained at the end of step 3, 10% of carbon super P-C65 and 10% of polyvinylidene difluoride (PVDF). After coating onto an aluminum foil and then drying under vacuum at a temperature of 60° C. for a time of 24 hours, electrodes are cut out and then calendered in a glovebox and finally dried for a time of 48 hours under vacuum, at a temperature of 80° C.

Lithiation of one of the cut-out electrodes is performed as a button cell (format CR2032). The electrode defines a positive electrode and a lithium metal counterelectrode is used. A cell separator is formed from a layer of Videlon and a layer of Celgard 2400. The electrolyte is constituted of a mixture of one part by volume of ethyl carbonate (EC), one part by volume of dimethyl carbonate (DMC) and one part by volume of ethyl methyl carbonate (EMC), in which is dissolved lithium hexafluorophosphate (LiPF₆) in a concentration of 1 mol/l. A first discharge is performed at a regime of C/10 (1C=174 mA/g) so as to introduce lithium ions into the Mg_{z}MnSiO₄ material of the positive electrode. Next, a succession of galvanostatic charging-discharging cycles is imposed at a regime of C/5 between 1.5 V and 4.8 V vs Li⁺/Li, at room temperature.

FIG. 6 shows the change 20 in the course of a charging-discharging cycle of the potential 22 of the LiₐMg_{z}MnSiO₄ positive electrode (a<1) as a function of the net specific capacitance of active material 24. In the course of charging 26, Li⁺ ions are deinserted from the LiₐMg_{z}MnSiO₄ positive electrode and are deposited onto the negative electrode, so that a material of formula Li_{a′}Mg_{z}MnSiO₄ (with a′<a) is formed. In the course of discharging 28, the reverse redox reactions take place.

FIG. 7 represents the change 30 in the specific capacitance of the positive electrode 32 in discharging as a function of the number of cycles 34.

As is observed, a reversible specific capacitance of greater than 110 mAh/g is obtained for the composite formed by the lithiated silicate.

Moreover, both during charging and discharging, the electrochemically active material of the positive electrode keeps its olivine crystallographic structure, as may be observed by X-ray diffraction.

Finally, the material according to the invention has excellent thermal stability, and it is formed from elements that are less expensive and less environmentally unfriendly than the materials of the prior art.

Needless to say, the invention is not limited to the embodiments of the product and to the embodiments of the method presented in the present description.

Moreover, unless otherwise mentioned, an inequality of the type “A greater than B” or, respectively, “A less than B” is considered strictly. In other words, equality between A and B is excluded. Moreover, the expressions “comprising a” and “comprising at least one” are equivalent.

1. Product constituted totally or partly by a material of olivine crystallographic structure of formula (I):
AₐZ_{z}MₘSiO₄
in which:
A is chosen from lithium (Li), sodium (Na), potassium (K), and mixtures thereof,
Z is chosen from beryllium (Be), magnesium (Mg), calcium (Ca), strontium (Sr), barium (Ba), and mixtures thereof,
M is chosen from iron (Fe), nickel (Ni), cobalt (Co), manganese (Mn), chromium (Cr), and mixtures thereof,
a, z and m are the stoichiometric coefficients, respectively, of A, Z and M, and satisfy the following conditions:
z>0, m>0, a>0,
a+z+m≦2, and
2≦(4−a−2z)/m>4.

2. Product according to claim 1, in which a+z+m=2.

3. Product according to claim 1, in which z=1−a and/or m=1.

4. Product according to claim 1, in which z<1, preferably z<0.5, preferably z<0.1, or even preferably z<0.05, better still z<0.01.

5. Product according to claim 1, in which A comprises, as molar percentages expressed relative to the total number of moles of constituent alkali metal A, more than 90% of lithium and/or potassium and/or sodium.

6. Product according to claim 5, in which A is constituted to more than 99% of lithium, as a molar percentage expressed relative to the total number of moles of constituent alkali metal A.

7. Product according to claim 6, in which A is lithium.

8. Product according to claim 1, in which Z is chosen from magnesium, calcium, and mixtures thereof.

9. Product according to claim 8, in which Z is magnesium.

10. Product according to claim 1, in which m is between 0.9 and 1.1, preferably equal to 1.

11. Product according to claim 1, in which the material of formula (I) is in the form of primary particles less than 100 nm in size.

12. Product according to claim 11, in which the primary particles are aggregated or agglomerated together.

13. Product according to claim 11, in which the primary particles are covered, preferably entirely, with a layer of carbon less than 10 nm thick.

14. Manufacturing method comprising at least the successive steps consisting in:
a) having a first material comprising at least one alkali metal A chosen from lithium (Li), sodium (Na), potassium (K), and mixtures thereof, and a second material of olivine crystallographic structure of formula (III):
Z_{z}MₘSiO₄,
in which:
Z is chosen from beryllium (Be), magnesium (Mg), calcium (Ca), strontium (Sr), barium (Ba), and mixtures thereof,
M is chosen from iron (Fe), nickel (Ni), cobalt (Co), manganese (Mn), chromium (Cr) and mixtures thereof,
z′>z, z being as defined previously, and
z and m are the stoichiometric coefficients, respectively, of Z and M, and satisfy the following condition:
z>0, m>0,
b) maintaining a liquid bath comprising, preferably constituted by, the first molten material and the second material in solid form, at a maintenance temperature and for a maintenance time at this temperature that are suitable for the insertion of an alkali metal A chosen from lithium (Li), sodium (Na), potassium (K), and mixtures thereof, and provided by the first material in free sites of the olivine crystallographic structure of the second material so as to form a product according to any one of the preceding claims,
c) optionally, cooling of the liquid bath, and
d) optionally, washing and then drying.

15. Method according to claim 14, in which the liquid bath is obtained by partial melting of a starting feed constituted of particles formed from the first material and of particles formed from the second material, and preferably intimately mixed.

16. Method according to claim 15, in which the partial melting is performed at a temperature above the melting point of the first material and below the degradation temperature of the second material.

17. Method according to claim 14, in which, in step b), the maintenance temperature is above the melting point of the first material and below the degradation temperature of the second material, and is, for example, between 200° C. and 500° C.

18. Method according to

14, in which the first material is a mixture of LiNO₃ and LiCl or a mixture of LiCl and KCl.

19. Device chosen from a battery cathode, especially chosen from a lithium-ion (Li-ion) battery cathode, a sodium-ion (Na-ion) battery cathode, a potassium-ion (K-ion) battery cathode, a lithium (Li) battery cathode, a sodium (Na) battery cathode and a potassium (K) battery cathode, said battery cathode comprising a product according to claim 1.
